(19) United States
(12) Patent Application Publication
(10) Pub. No.: US 2003/0220143 A1
(43) Pub. Date: Nov. 27, 2003

(54) On-line gaming spectator

(75) Inventors: Yevgeniy E. Shteyn, Cupertino, CA (US); Michael Schmitt, Portland, OR (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 10/155,322

(22) Filed: May 24, 2002

(51) Int. Cl. A63F 13/00

(52) U.S. Cl. 463/42

(57) ABSTRACT

Participatory spectator roles are provided to on-line gaming systems. The degree of a spectator's participation can vary from that of an observer to that of a critic. Similarly, the degree of effect that the spectator can have on the active-players of the on-line game may also vary. The spectator receives input at various sense levels, video, audio, touch, and so on, and may provide feedback to the active-players of the on-line game using the same or different sense levels. The spectator may also be able to effect changes in the on-line game environment, by modifying landscapes and obstacles, providing clues, defining new rules or challenges, interacting with the active-players, and so on.

### BACKGROUND OF THE INVENTION

1. Field of the Invention

This invention relates to the field of computer systems, and in particular to an on-line gaming system that includes spectator functions.

2. Description of Related Art

On-line gaming systems are common in the art. Typically, two or more players interact competitively in a game environment, each player taking an active part. Typically, a program on a host computer controls the interactions between the players at client systems. The client systems each contain programs and data that facilitate a timely display of the actions of each of the other players, based on information received from the host computer. Data templates that represent a variety of different scenes or sub-scenes, for example, may be pre-downloaded to each client system, so that the host computer need merely communicate select parameters to effect a scene change at each client system. Such techniques are provided to assure a rapid time response among the players, to enhance the sense of realism of the on-line game.

In addition to gaming systems that involve direct player-to-player competition, such as a multi-player race-car game, or a multi-player poker game, some gaming systems involve a third-party participant, whose actions are controlled by the host computer. Such systems include, for example, a traditional game of blackjack, wherein the third-party is a computer-controlled “dealer” with which each of the players interacts. Or, the third-party may be an entire set of simulated items, such as two simulated football teams, each team having characters or characteristics that are controlled by the players. The degree of player interaction varies, depending upon the particular role of the player. In some games, for example, the player may be the quarterback, who calls the plays and then actively participates as a one of the members of the team on the field; in other scenarios, the player is the coach, who determines overall strategy, substitutes team-members, and so on; in yet other scenarios, the player is the owner or manager, who selects the team-members; in other scenarios, the player is merely the gambler, who places bets on the outcome of the on-line game, or parts of the on-line game.

As is known in the art, the success of an on-line game is strongly correlated to the sense of realism that is conveyed during the game. In an example horse-race game, if the player is a jockey, the scene that is conveyed to the player should be from the perspective of a horse-back rider, with the sounds of clopping hooves, shouts from other jockeys, and so on. If the player is the gambler, the scene should be from the perspective of a person in the viewing stands, with the sounds of the race-announcer, surrounding crowds, and so on.

As is also known in the art, the success of an on-line game is strongly correlated to the desirability of the roles provided to the players. If a person's interest lies in controlling a vehicle at high speeds through a complex raceway, that person might not be interested in merely placing a bet on the outcome of a computer-simulated race. If the person's interest lies in picking and choosing the combination of talents that are likely to succeed in a team competition, that person might not be interested in participating in the competition directly.

As is also known in the art, the success of on-line games, in general, is often diminished by the “isolation-factor” introduced by on-line games. Generally, unless all the people in a physical environment, such as a home, enjoy participating in the same on-line game, a person who plays the on-line game is isolated from the remainder of the people in this environment.

### BRIEF SUMMARY OF THE INVENTION

It is an object of this invention to enhance the realism of on-line gaming. It is a further object of this invention to expand the scope of available user interactions for on-line gaming. It is a further object of this invention to increase the revenues achievable by providers of on-line gaming.

These objects and others are achieved by providing participatory spectator roles to on-line gaming systems. The degree of a spectator's participation can vary from that of an observer to that of a critic. Similarly, the degree of effect that the spectator can have on the active-players and/or other spectators of the on-line game may also vary. The spectator receives input at various sense levels, video, audio, touch, and so on, and may provide feedback to the active-players and/or spectators of the on-line game using the same or different sense levels. The spectator may also be able to effect changes in the on-line game environment, by modifying landscapes and obstacles, providing clues (which may be false), defining new rules or challenges, interacting with the active-players, and so on. The spectator may also be enabled to interact, with for example the game host, to provide and/or sponsor a variety of game equipment resources to enhance the active player's performance. The spectator may further be enabled to assume a critic's role in order to provide feedback, such as play-by-play commentary, game view selection, and so on to a plurality of other spectators, such as the player's family members and friends. A third party, such as a game host, may collect fees for access to the critique. The critique materials may also be used to mask game performance delays, such as caused by network latency.

### BRIEF DESCRIPTION OF THE DRAWINGS

The invention is explained in further detail, and by way of example, with reference to the accompanying drawings wherein:

FIG. 1 illustrates an example block diagram of an on-line gaming system in accordance with this invention.

FIG. 2 illustrates an example flow diagram for providing participatory spectator functions to a user in accordance with this invention.

Throughout the drawings, the same reference numerals indicate similar or corresponding features or functions.

### DETAILED DESCRIPTION OF THE INVENTION

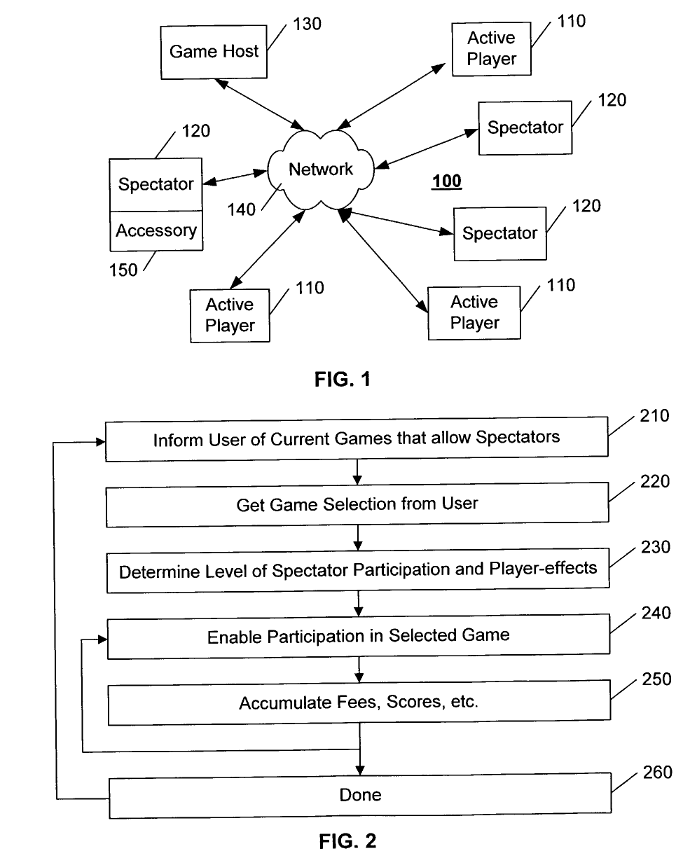

FIG. 1 illustrates an example block diagram of an on-line gaming system 100 in accordance with this invention. As illustrated, the system 100 is configured to allow both active-players 110 and spectators 120 to participate in the on-line game that is hosted by the game host 130, via a network 140, such as a local area network (LAN), the Internet, or other wide-area network (WAN). The indicated items 110, 120 correspond to user devices that are configured by the respective users to effect either an active-player role or a spectator role. For ease of reference, except as otherwise noted, the terms active-player 110 and active-player device 110 are used synonymously, as are spectator 120 and spectator device 120.

Active-players 110 are defined herein as participants whose actions form a fundamental part of the on-line game, whereas spectators 120 are participants whose actions, if any, are optional. Alternatively stated, the host 130 of the on-line game receives inputs from active-players 110 that are specifically intended to affect the state of the on-line game; inputs, if any, from spectators 120 may or may not affect the state of the on-line game.

The particular device that a user uses to participate in the on-line game, as an active-player 110 or a spectator 120, may include any device that is configured to effect the selected role, such as a personal computer (PC), a personal data assistant (PDA), a set-top box, a customized hardware device, and the like.

In the simplest example embodiment, a spectator 120 merely observes the actions of the players, via an audio and/or video transmission of events from the host 130 to the spectator 120, or directly from one or more of the active-players 110. At a higher level of interaction, the spectator 110 is coupled to a particular active-player 110, and receives stimuli corresponding to the actions of this particular active-player 110. For example, the spectator 110 may receive the same view of the gaming environment as the active-player 110, or may receive a slightly offset view, corresponding, for example, to sitting aside the active-player 110 during an automobile race. Depending upon the configuration of the spectator's system, the spectator 120 may receive tactile feedback as well, corresponding to the actions of the active-player 110, such as feeling the push of a button and the movement of a joystick, or corresponding to the effects on the active-player 110 caused by other players 110.

One of ordinary skill in the art will recognize that a spectator role provides an additional pool of potential users, or potential additional use by current gaming users. Some people naturally prefer a spectator role, rather than an active role. By enhancing the spectator role to include stimuli corresponding to a particular active-player 110, the spectator 120 has an increased sense of participation in the on-line game. Some people may prefer a spectator role in certain situations, and an active role in other situations. For example, a user may wish to ‘passively’ participate in a game by being a spectator when the user is involved in another activity, such as when the user is ‘marking time’ waiting for a telephone call, or waiting in a doctor's office, or attending a boring meeting. Because the spectator role is non-essential to the on-line game, the user can drop out of the game as required to attend to matters in the real world. In another example, a user who wants to become an active-player 110 may use the role of spectator 120 as a training vehicle to learn the game. A user may become a spectator 120 associated with a particular active-player 110, to learn the actions and reactions of this active-player 110, either to emulate the player 110, or to gain an advantage for subsequent competitions with this player 110. In a social environment, partners may share the gaming experience by having one partner in the role of active-player 110, and the other partner in the role of spectator 120.

The spectator interaction can be further enhanced by allowing the spectator 120 to influence one or more of the active-players 110.

In a relatively simple embodiment, the spectator 120 provides comments to one or more of the active-players 110 and/or other spectators 120. In addition to enhancing the spectator's involvement with the on-line game, this feature also increases the realism of the on-line game for the active-player 110. Most conventional games provide background audio sounds, including cheers and jeers, but these background sounds are non-specific to the active-player's actions. Cheers may be triggered by a successful action on the part of the active-player 110, and jeers by an unsuccessful action, but such feedback is not as realistic as an immediate comment by a current observer of the action. In a social environment, supportive or empathetic comments by a spectator partner 120 enhance the experience of the active-player 110 or another spectator 120. Providing video images of the spectator 120 to one or more of the active-players 110 or spectators 120 can further enhance the interaction. In like manner, the spectator 120 may also be provided the opportunity to send pre-recorded audio or audio-video selections to the active players 110 as the situation warrants, for example during game intermissions, equipment delays, and so on. If the spectator 120 and active-player 110 are suitably equipped, the interactions may also include tactile feedback, such as a congratulatory “pat on the back”.

The feedback that is provided by the spectators can also serve to enhance the perceived performance of the online game. U.S. Pat. No. 6,356,288, “DIVERSION AGENT USES CINEMATOGRAPHIC TECHNIQUES TO MASK LATENCY”, issued Mar. 12, 2002 to Martin Freeman and Yevgeniy Shteyn, discloses a technique of creating cinematographic effects at a user display, to mask the latency that is common in online gaming due to transmission delays and latency, and is incorporated by reference herein. In combination with the principles of this referenced patent, for example, the feedback from the spectator can be presented in cinematographic form while the online game information is being received and buffered, thereby masking the delays caused by network latency or other factors that cause delay in presenting updates to the online game.

In a more complex environment, the spectators 120 may provide advice or suggestions to the active-players 110, which advice and suggestions may be true or false. Such interactions increase the dynamics of the on-line game, as well as increasing the realism, because in the ‘real world’, active participants are often given advice and suggestions from bystanders and others. The interaction can be further enhanced by allowing the spectators 120 to directly interact with the active-players 110. In a survival game, for example, the spectator 120 may be permitted to enter into transactions with an active player 120 to sell supplies or information; in a racing game, the spectator may sell gasoline or repair parts to an active player 110, or may contribute services as part of a pit-crew. In another embodiment, an optional accessory 150 may be coupled to spectator device 120. Input/output from the accessory 150 may be directly or indirectly used to contribute to a selected player's 110 performance. For example, the accessory 150 may be a stationary bike that is attached to a spectator device 120. The spectator contributes to the selected player's 110 performance, such as racing speed, by working out on the bike accessory 150. A specific characteristic of the workout, such as the calories burned, or the number of revolutions of the pedals of the bike 150, may be selected as a factored contribution. A plurality of spectators at one or more locations, for example, family members, a gym team, and so on, may also be enabled to contribute to the player's 110 performance. Spectators may also be permitted to act as an umpire or judge within the on-line game. Combining these interactions, a nefarious spectator 120, for example, might seek the role of umpire, and then proceed to negotiate with an active-player 110 for the sale of favorable decisions. One of ordinary skill in the art will recognize that various levels of interaction between the spectators 120 and active-players 110 are feasible, and will generally increase the realism and interest in the on-line game for both the spectators 120 and the active-players 110.

In accordance with another aspect of this invention, the spectators 120 are able to influence the on-line game environment that is provided by the host computer 130. Depending upon the particular game, the spectator 120 may affect the weather conditions within the gaming environment, set or adjust barriers and impediments, provide or modify shortcuts, and so on. The spectator 120 may also be provided the ability to change the background and landscapes of the gaming environment, and may even be provided the ability to change the rules and objectives of the on-line game. One of ordinary skill in the art will recognize, however, that a proper balance should be maintained, so that active players are not driven away from the on-line game because of the changes that a spectator introduces. This balance may be imposed by imposing specific limits and bounds on the degree of spectator influence, or a dynamic balance may be achieved via the use of learning systems techniques. That is, the allowable interaction may be modified with a corresponding monitoring of active-player drop-out rate, and the system may be configured to continually modify the allowable interactions so as to minimize the drop-out rate. Because the correlation between particular types of allowable interactions and the active-player drop-out rate may be difficult to determine, learning systems that employ heuristic techniques, such as evolutionary or genetic algorithms, would be particularly well suited for dynamically controlling the degree of spectator interaction for minimizing the active-player drop-out rate and maximizing the spectator participation rate. In like manner, the effect that a particular spectator 120 may have on the on-line game may be attenuated or enhanced based on the feedback from other spectators 120. As would be evident to one of ordinary skill in the art, appropriate security measures, such as the use of passwords or other forms of certification, are included in a preferred embodiment, to avoid tampering, impersonation, and other forms of inappropriate behavior that might affect the quality or reliability of spectator interactions.

FIG. 2 illustrates an example flow diagram for providing participatory spectator functions to a user in accordance with this invention. In a preferred embodiment, the provider of the spectator functions is associated with one or more providers of the on-line games. The user contacts the provider via the Internet, and the provider informs the user of the on-line games that are currently in play, or that are scheduled for play, at 210. Depending upon the available games, and/or upon a membership status of the user, the user is preferably provided a choice among various levels of interaction, each level of interaction having a different cost factor. For example, lower levels of interaction may be free of charge, intermediate levels may have a time-based fee, and higher levels may be reserved for subscription members, or for active-players of prior games. Other common pricing structures may be used, including season passes, bonus plays, and rates that are dependent upon the time-of-day, the particular type of game, the connection speed, and so on. The potential spectator may also be given aggregated or personal information with regards to the number of spectators in a particular game, spectators' ratings, affiliation and so on

At 220 and 230, the user selects the particular game, and the level of interaction, respectively. As noted above, the spectator interaction level includes both the level of spectator participation as well as the effects that the participation may have on the players and/or the on-line game environment. At 240, the spectator is provided access to the on-line game, at the selected level of participation. During the spectating period, the provider system records the appropriate fees and other records associated with the on-line game. For example, if the spectator is permitted to interact with the active-players to negotiate the sale of material or services, the system records the costs charged to the spectator to obtain the material or services, and the payments due from each active-player to this spectator based on the negotiated sale. In a preferred embodiment, these payments are effected using game-time credits, to stimulate subsequent game participation. When the user terminates the current session, at 260, the system returns to 210, to inform the user of other current or future games.

In a preferred embodiment, the current and future games are provided in an “Electronic Program Guide” (EPG) format, similar to the EPGs that are provided for television programs. When the user selects a game, the spectator, using techniques common in the art of remote games, configures the providing system to download graphic files and other program files that facilitate an efficient interaction.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the invention is presented in the context of independent spectators, the system may be configured to consolidate the responses from a plurality of spectators before an effect is presented to the active-players. In like manner, spectator groups may be established, via, for example, a chat-room, and a group response may be provided to the active-players. Using multi-screen display techniques, the spectator may participate in multiple games while also communicating with one or more groups of spectators. These and other system configuration and optimization features will be evident to one of ordinary skill in the art in view of this disclosure, and are included within the scope of the following claims.

I claim:

1. A method of providing entertainment to a user, including:
receiving a request from the user to be a spectator at an on-line game that is effected by one or more active-players, and
providing stimuli to the user corresponding to activities of the on-line game.

2. The method of claim 1, wherein
the stimuli includes at least one of:
audio stimuli,
visual stimuli, and
tactile stimuli.

3. The method of claim 1, further including
receiving feedback from the user, and
providing the feedback to at least one active-player of the one or more active-players.

4. The method of claim 3, wherein
the feedback includes at least one of:
audio feedback,
visual feedback,
tactile feedback, and
a change of environment within the game.

5. The method of claim 3, wherein
the feedback corresponds to a measure of contribution to at least one active-player of the one or more active-players, and
a performance characteristic of the at least one active-player is based at least in part on the measure of contribution.

6. The method of claim 3, wherein
providing the feedback to at least one active-player is effected while information related to the on-line game is being communicated to a receiving device of the at least one active-player.

7. The method of claim 1, further including
assessing a fee to the user.

8. The method of claim 7, wherein
the fee is based on at least one of:
a level of participation of the user,
a level of player-effects allowed to the user,
a level of game-effects allowed to the user,
a duration of participation by the user,
a time-of-day of the on-line game,
a classification of the on-line game,
a classification of the user, and
a type of connection to the user.

9. The method of claim 1, further including:
downloading select game-related information to the user prior to providing the stimuli.

10. The method of claim 1, further including
providing a guide to available on-line games, from which the user selects the on-line game.

11. The method of claim 1, further including
enabling transactions between the user and at least one of the one or more active-players.

12. The method of claim 1, further including
enabling communication between the user and one or more other spectators to the on-line game.

13. The method of claim 12, further including
modifying the game based on a composite feedback of the user and the one or more other spectators.

14. A computer program that, when executed on a computer system, causes the computer system to:
receive player-input from one or more active-players of an on-line game,
update a state of the on-line game based on the player-input,
transmit updated game information to the one or more active-players, based on the state of the on-line game, and
transmit updated spectator information to one or more spectators, based on at least one of:
the player-input, and
the state of the on-line game.

15. The computer program of claim 14, wherein
the spectator information includes at least one of:
audio information,
visual information, and
tactile information.

16. The computer program of claim 14, which further causes the computer system to:
receive spectator-input from the one or more spectators, and
transmit the spectator-input to at least one of the one or more active-players.

17. The computer program of claim 14, which further causes the computer system to:
receive spectator-input from the one or more spectators, and
further update the state of the on-line game based on the spectator-input.

18. The computer program of claim 14, which further causes the computer system to:
receive spectator-input from the one or more spectators, and
update a performance characteristic of at least one of the one or more active-players, based on the spectator-input.

19. The computer program of claim 14, which further causes the computer system to:
facilitate communications among the one or more spectators.

20. The computer program of claim 14, which further causes the computer system to:
assess fees to at least one spectator of the one or more spectators, based on at least one of:
a level of participation of the at least one spectator,
a level of player-effects allowed to the at least one spectator,
a level of game-effects allowed to the at least one spectator,
a duration of participation by the at least one spectator,
a time-of-day of the on-line game,
a classification of the on-line game,
a classification of the at least one spectator, and
a type of connection to the at least one spectator.

21. The computer program of claim 14, which further causes the computer system to:
transmit a guide to available on-line games to a user,
process a selection of the on-line game from among the available on-line games by the user, and
allow the user to be a spectator of the one or more spectators of the on-line game.

22. An on-line gaming system comprising:
a first software component for implementation on a host system that is configured to control an on-line game in response to inputs from one or more active-players of the on-line game,
a second software component for implementation on each computer system of the one or more active-players that is configured to render a state of the on-line game corresponding to each of the one or more active-players, and to communicate the inputs from each of the one or more active-players to the host system,
the first software component being further configured to modify the state of the on-line game in response to the inputs from each of the one or more active-players, and,
a third software component for implementation on each computer system of one or more spectators to the on-line game that is configured to render the state of the on-line game corresponding to each of the one or more spectators.

23. The on-line gaming system of claim 22, wherein
the third software component is also configured to communicate feedback from each of the one or more spectators to the host system.

24. The on-line gaming system of claim 23, wherein
the first software component is further configured to modify the state of the on-line game in response to the feedback from at least one of the one or more spectators.

25. The on-line gaming system of claim 23, wherein
the first software component is further configured to communicate the feedback from the at least one of the one or more spectators to at least one of the one or more active-players.

26. The on-line gaming system of claim 23, wherein
the first software component is further configured to modify a perfomance characteristic of at least one of the one or more active-players, based at least in part on the feedback from at least one of the one or more spectators.
